(19) United States
(12) Patent Application Publication
(10) Pub. No.: US 2024/0004629 A1
(43) Pub. Date: Jan. 4, 2024

(54) COMPUTER SOFTWARE UPDATES VIA BLOCKCHAIN

(71) Applicant: Dell Products L.P., Round Rock, TX (US)

(72) Inventors: Achint Singh, Bangalore (IN); Prasanth K S R, Bangalore (IN); Shubham Kumar, Chakradharpur (IN); Manjunath Gr, Bangalore (IN); Rajat Sharma, Jaipur (IN); Tomson Mt, Kasaragaod (IN); Sumanth Vidyadhara, Bangalore (IN)

(21) Appl. No.: 17/854,157

(22) Filed: Jun. 30, 2022

(51) Int. Cl. G06F 8/65; G06F 8/61; H04L 9/00; H04L 9/32

(52) U.S. Cl. CPC G06F 8/65; G06F 8/61; H04L 9/50; H04L 9/3218

(57) ABSTRACT

Client machines, whether consumer or Enterprise, are notified of software updates using a decentralized, peer-to-peer blockchain infrastructure. Any software update is written to a block of data and distributed to blockchain nodes associated with a blockchain network. A smart contract, executed by any of the blockchain nodes, causes the corresponding blockchain node to notify specific client machines of the block of data recording the software update. The client machines contact the blockchain node and request the software update written to the block of data. The blockchain node retrieves and sends the software update written to the block of data. When the client machines receive the software update, the client machines apply or install the software update to improve their computer functioning.

### FIELD OF THE DISCLOSURE

This disclosure generally relates to information handling systems, and more particularly relates to providing computer software updates via one or more decentralized blockchain networks.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources configured to process, store, and communicate information and may include one or more computer systems, data storage systems, and networking systems.

### SUMMARY

Client machines, whether consumer or Enterprise, are notified of software updates using a decentralized, peer-to-peer blockchain infrastructure. Any software update is written to a blockchain's block of data and distributed to blockchain nodes associated with a blockchain network. A smart contract, executed by any of the blockchain nodes, causes the corresponding blockchain node to notify specific client machines of the block of data recording the software update. The client machines contact the blockchain node and request the software update written to the block of data. The blockchain node retrieves and sends the software update written to the block of data. When the client machines receive the software update from the blockchain node, the client machines apply or install the software update to improve their computer functioning.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a generalized information handling system;

FIG. 2 is a general illustration of blockchain-based computer configuration, according to exemplary embodiments;

FIG. 3 illustrates improved computer functioning, according to exemplary embodiments;

FIG. 4 is a flowchart or algorithm illustrating a decentralized, peer-to-peer blockchain-based software update scheme for consumer devices, according to exemplary embodiments;

FIG. 5 is a block diagram illustrating a blockchain-based configuration scheme for commercial devices operating in an Enterprise network, according to exemplary embodiments;

FIG. 6 is a flowchart or algorithm illustrating a decentralized, peer-to-peer blockchain-based configuration scheme for Enterprise commercial client machines, according to exemplary embodiments; and

FIG. 7 illustrates general scalability of decentralized, peer-to-peer blockchain-based configurations, according to exemplary embodiments.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings.

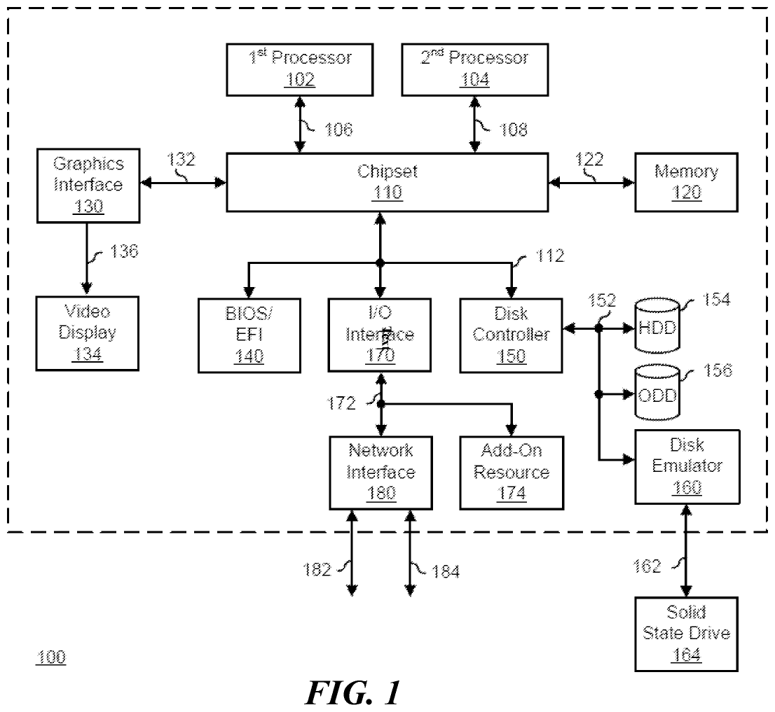

FIG. 1 illustrates an embodiment of an information handling system 100 including processors 102 and 104, chipset 110, memory 120, graphics adapter 130 connected to video display 134, non-volatile RAM (NV-RAM) 140 that includes a basic input and output system/extensible firmware interface (BIOS/EFI) module 142, disk controller 150, hard disk drive (HDD) 154, optical disk drive (ODD) 156, disk emulator 160 connected to solid state drive (SSD) 164, an input/output (I/O) interface 170 connected to an add-on resource 174, and a network interface device 180. Processor 102 is connected to chipset 110 via processor interface 106, and processor 104 is connected to chipset 110 via processor interface 108.

Chipset 110 represents an integrated circuit or group of integrated circuits that manages data flow between processors 102 and 104 and the other elements of information handling system 100. In a particular embodiment, chipset 110 represents a pair of integrated circuits, such as a north bridge component and a south bridge component. In another embodiment, some or all of the functions and features of chipset 110 are integrated with one or more of processors 102 and 104. Memory 120 is connected to chipset 110 via a memory interface 122. An example of memory interface 122 includes a Double Data Rate (DDR) memory channel, and memory 120 represents one or more DDR Dual In-Line Memory Modules (DIMMs). In a particular embodiment, memory interface 122 represents two or more DDR channels. In another embodiment, one or more of processors 102 and 104 include memory interface 122 that provides a dedicated memory for the processors. A DDR channel and the connected DDR DIMMs can be in accordance with a particular DDR standard, such as a DDR3 standard, a DDR4 standard, a DDR5 standard, or the like. Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like.

Graphics adapter 130 is connected to chipset 110 via a graphics interface 132, and provides a video display output 136 to a video display 134. An example of a graphics interface 132 includes a peripheral component interconnect-express interface (PCIe) and graphics adapter 130 can include a four lane (×4) PCIe adapter, an eight lane (×8) PCIe adapter, a 16-lane (×16) PCIe adapter, or another configuration, as needed or desired. In a particular embodiment, graphics adapter 130 is provided on a system printed circuit board (PCB). Video display output 136 can include a digital video interface (DVI), a high definition multimedia interface (HDMI), DisplayPort interface, or the like. Video display 134 can include a monitor, a smart television, an embedded display such as a laptop computer display, or the like.

NV-RAM 140, disk controller 150, and I/O interface 170 are connected to chipset 110 via I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller 150 to HDD 154, to ODD 156, and to disk emulator 160. Disk interface 152 may include an integrated drive electronics (IDE) interface, an advanced technology attachment (ATA) such as a parallel ATA (PATA) interface or a serial ATA (SATA) interface, a SCSI interface, a USB interface, a proprietary interface, or a combination thereof. Disk emulator 160 permits a solid-state drive (SSD) 164 to be connected to information handling system 100 via an external interface 162. An example of external interface 162 includes a USB interface, an IEEE 1394 (Firewire) interface, a proprietary interface, or a combination thereof. Alternatively, SSD 164 can be disposed within information handling system 100.

I/O interface 170 includes a peripheral interface 172 that connects I/O interface 170 to add-on resource 174, to TPM 176, and to network interface device 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a sound card, data storage system, an additional graphics interface, another add-on resource, or a combination thereof. Add-on resource 174 can be on a main circuit board, a separate circuit board or an add-in card disposed within information handling system 100, a device that is external to the information handling system, or a combination thereof.

Network interface device 180 represents a network communication device disposed within information handling system 100, on a main circuit board of the information handling system, integrated onto another element such as chipset 110, in another suitable location, or a combination thereof. Network interface device 180 includes a network channel 182 that provides an interface to devices that are external to information handling system 100. In a particular embodiment, network channel is of a different type than peripheral channel 172 and network interface device 180 translates information from a format suitable to the peripheral channel to a format suitable to external devices. In a particular embodiment, network interface device 180 includes a host bus adapter (HBA), a host channel adapter, a network interface card (NIC), or other hardware circuit that can connect the information handling system to a network. An example of network channel 182 includes an InfiniBand channel, a fiber channel, a gigabit Ethernet channel, a proprietary channel architecture, or a combination thereof. Network channel 182 can be connected to an external network resource (not illustrated). The network resource can include another information handling system, a data storage system, another network, a grid management system, another suitable resource, or a combination thereof.

The information handling system 100 may include a baseboard management controller (BMC). The BMC is connected to multiple elements of information handling system 100 via one or more management interface to provide out of band monitoring, maintenance, and control of the elements of the information handling system. As such, BMC represents a processing device different from processors 102 and 104, which provides various management functions for information handling system 100. In an embodiment, BMC may be responsible for granting access to a remote management system that may establish control of the elements to implement power management, cooling management, storage management, and the like. The BMC may also grant access to an external device. In this case, the BMC may include transceiver circuitry to establish wireless communications with the external device such as a mobile device. The transceiver circuitry may operate on a Wi-Fi channel, a near-field communication (NFC) channel, a Bluetooth or Bluetooth-Low-Energy (BLE) channel, a cellular based interface such as a global system for mobile (GSM) interface, a code-division multiple access (CDMA) interface, a universal mobile telecommunications system (UMTS) interface, a long-term evolution (LTE) interface, another cellular based interface, or a combination thereof. A mobile device may include Ultrabook, a tablet computer, a netbook, a notebook computer, a laptop computer, mobile telephone, a cellular telephone, a smartphone, a personal digital assistant, a multimedia playback device, a digital music player, a digital video player, a navigational device, a digital camera, and the like.

The term BMC may be used in the context of server systems, while in a consumer-level device a BMC may be referred to as an embedded controller (EC). A BMC included at a data storage system can be referred to as a storage enclosure processor. A BMC included at a chassis of a blade server can be referred to as a chassis management controller, and embedded controllers included at the blades of the blade server can be referred to as blade management controllers. Out-of-band communication interfaces between BMC and elements of the information handling system may be provided by management interface that may include an inter-integrated circuit (I2C) bus, a system management bus (SMBUS), a power management bus (PMBUS), a low pin count (LPC) interface, a serial bus such as a universal serial bus (USB) or a serial peripheral interface (SPI), a network interface such as an Ethernet interface, a high-speed serial data link such as PCIe interface, a network controller-sideband interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

In an embodiment, the BMC implements an integrated remote access controller (iDRAC) that operates to monitor and maintain system firmware, such as code stored in BIOS/EFI module 142, option ROMs for graphics interface 130, disk controller 150, add-on resource 174, network interface 180, or other elements of information handling system 100, as needed or desired. In particular, BMC includes a network interface that can be connected to a remote management system to receive firmware updates, as needed or desired. Here BMC receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC utilizes various protocols and application programming interfaces (APIs) to direct and control the processes for monitoring and maintaining the system firmware. An example of a protocol or API for monitoring and maintaining the system firmware includes a graphical user interface (GUI) associated with BMC, an interface defined by the Distributed Management Taskforce (DMTF) (such as Web Services Management (WS-MAN) interface, a Management Component Transport Protocol (MCTP) or, Redfish interface), various vendor defined interfaces (such as Dell EMC Remote Access Controller Administrator (RACADM) utility, Dell EMC Open Manage Server Administrator (OMSS) utility, Dell EMC Open Manage Storage Services (OMSS) utility, Dell EMC Open Manage Deployment Toolkit (DTK) suite), representational state transfer (REST) web API, a BIOS setup utility such as invoked by a “F2” boot option, or another protocol or API, as needed or desired.

In a particular embodiment, BMC is included on a main circuit board (such as a baseboard, a motherboard, or any combination thereof) of information handling system 100, or is integrated into another element of the information handling system such as chipset 110, or another suitable element, as needed or desired. As such, BMC can be part of an integrated circuit or a chip set within information handling system 100. BMC may operate on a separate power plane from other resources in information handling system 100. Thus BMC can communicate with the remote management system via network interface or the BMC can communicate with the external mobile device using its own transceiver circuitry while the resources or elements of information handling system 100 are powered off or at least in low power mode. Here, information can be sent from the remote management system or external mobile device to BMC and the information can be stored in a RAM or NV-RAM associated with the BMC. Information stored in the RAM may be lost after power-down of the power plane for BMC, while information stored in the NV-RAM may be saved through a power-down/power-up cycle of the power plane for the BMC.

These hardware and software resources (e.g., drivers, BIOS, firmware, and software applications) often require software updates to resolve performance, operability, and/or compatibility issues. However, computer users, whether consumers or corporate enterprise customers, often fail to update their computers.

In a typical usage case, information handling system 100 represents an enterprise class processing system, such as may be found in a datacenter or other compute-intense processing environment. Here, there may be hundreds or thousands of other enterprise class processing systems in the datacenter. In such an environment, the information handling system may represent one of a wide variety of different types of equipment that perform the main processing tasks of the datacenter, such as modular blade servers, switching and routing equipment (network routers, top-of-rack switches, and the like), data storage equipment (storage servers, network attached storage, storage area networks, and the like), or other computing equipment that the datacenter uses to perform the processing tasks.

Errors may be difficult to diagnose and to debug. Pre-boot errors (such as hardware errors occurring during a power-on self-test operation) are conventionally detected by the BIOS 142. In order to diagnose and to debug these pre-boot hardware errors, a more complex software stack (such as an operating system or OS) is required. A large and memory-intensive operating system, in other words, must be executed to diagnose and to debug problem issues such as network connectivity, GPU errors, MKTME-based errors, VPN, RADIUS Authentication (MS-CHAP), and other hardware-based errors. The conventional BIOS 142 lacks capabilities to resolve pre-boot errors.

Remote diagnosis is also challenging. Remote OS install and OS recovery on a bare metal computer machine may be accomplished using cloud-based service support (such as Dell's BIOSConnect platform that allows BIOS to connect to an HTTP backend and load an image). A bare metal computer machine refers to a computer executing instructions stored or written to logic hardware without the intervening operating system. However, the inventors have realized that a bare metal computer machine launching BIOSConnect over a VPN network is difficult to repeatedly accomplish. The BIOS 142 must include a network software stack for network connectivity, which is complex and time consuming to develop.

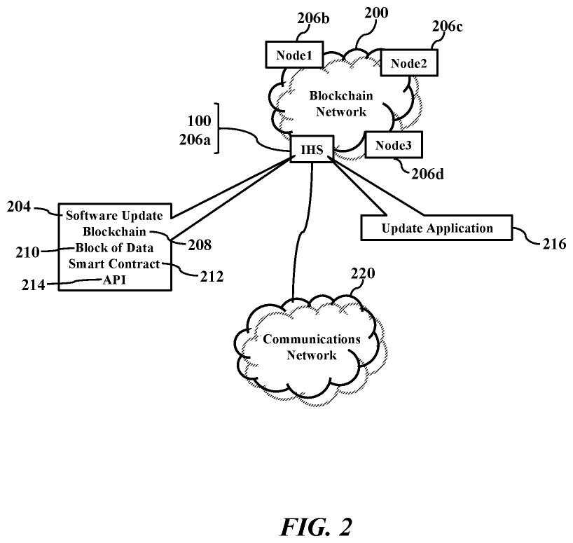

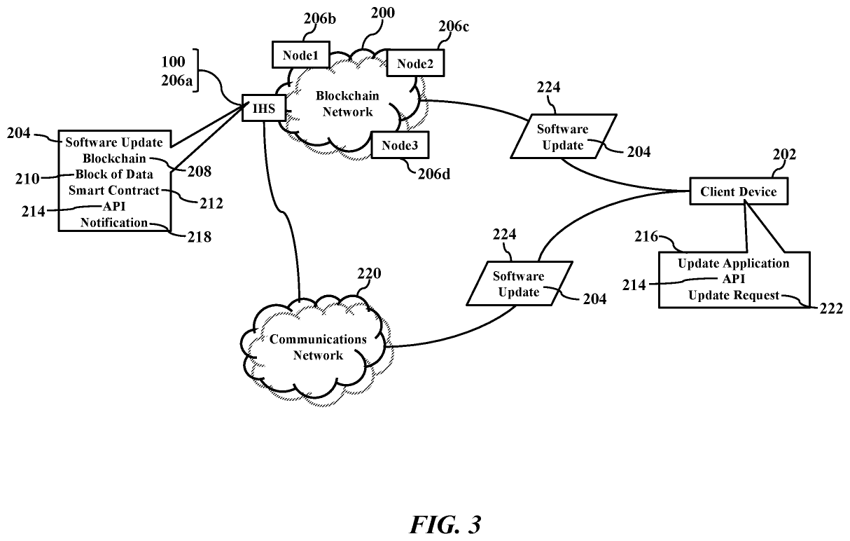

FIGS. 2-3 are general illustrations of blockchain-based computer configuration, according to exemplary embodiments. As FIG. 2 illustrates, exemplary embodiments may may utilize a decentralized, peer-to-peer blockchain network 200 to deploy a software update 204 (such as a new/latest/required computer configuration) to blockchain nodes 206 associated with a blockchain 208. The information handling system 100 may thus operate as one of many blockchain nodes (illustrated as reference numerals 206a-d) in the blockchain network 200. The information handling system 100 may read/write to the blockchain 208. FIG. 3, though, illustrates a notification scheme in which the information handling system 100 operates as one of the blockchain nodes 206, but the blockchain node 206 may function or operate as a computer server that serves the software update 204 to a client device 202. While FIGS. 2-3 only illustrate a few blockchain nodes 206a-d, in actual practice the blockchain network 200 may have many (perhaps hundreds or even thousands) of the information handling systems 100 operating as the blockchain nodes 206. All the blockchain nodes 206, associated with the blockchain network 200, may communicate with each other and exchange information with each other. The blockchain nodes 206, in particular, distribute, share, store, and synchronize electronic blocks 210 of data cryptographically forming the blockchain 208. Each blockchain node 206, in other words, stores an electronic copy of the blocks 210 of data associated with the blockchain 208. The blockchain 208, the blockchain nodes 206, and the blockchain network 200 are generally known, so this disclosure need not dwell on the known aspects of blockchain technologies.

Exemplary embodiments utilize the blockchain network 200 to deploy the software update 204. The software update 204 is written to the block 210 of data. When the block 210 of data is distributed across the blockchain network 200, each blockchain node 206 receives the software update 204 written to the block 210 of data. Because each blockchain node 206 stores an electronic copy of the block 210 of data, each blockchain node 206 also stores the software update 204 written to the block 210 of data. The blockchain network 200 has thus dispersed and distributed many copies (perhaps hundreds or even thousands) of the software update 204.

Programmatic actions may then be executed. Once the software update 204 is published to the blockchain 208, the block 210 of data and the software update 204 may be deployed to every blockchain node 206 and stored to its corresponding memory 120 (illustrated in FIG. 1). Any of the blockchain nodes 206 may execute a digital or smart contract 212 associated with the software update 204. The smart contract 212 may be appended to any of the block 210 of data associated with the blockchain 208. When the smart contract 212 is executed by the node 206, the smart contract 212 has programming that fetches the block 210 of data from the memory 120. The smart contract 212 exposes, reveals, utilizes or specifies application programming interfaces (or “APIs”) 214 for accessing the blockchain 208, the blockchain network 200, the blockchain node 206, the block 210 of data, and/or the software update 204. The smart contract 212 may also have APIs 214 for requesting, reading, retrieving, and sending the software update 204. The software update 204 may itself identify which clients are to receive the update (such as by specifying a make, model, serial number, and/or IP address associated with the client device 202). Additionally or alternatively, when the smart contract 212 is executed by the blockchain node 206, the smart contract 212 may reveal which client devices 202 are updated.

The blockchain network 200 thus deploys the software update 204. As FIG. 2 illustrates, the nodes 206 may store and execute an update software application 216 that interfaces with the smart contract 212, perhaps using the APIs 214. The update software application 216 uses the APIs 214 to register the node 206 with the smart contract 212 for software update notifications 218 (such as so-called call back or alert messages) when the software update 204 is available. So, when the software update 204 is written to the block 210 of data, the blockchain node 206 executes the smart contract 212 and retrieves the software update 204. The blockchain node 206 may then apply, download, and/or install the software update 204. The blockchain node 206 is thus updated with the latest software version or configuration for best performance, user experience, security, operability, and any other factor. The update software application 216 (such as a WEB3 application) may thus register an asynchronous callback method with the smart contract 212. The update software application 216 thus automatically gets the software update 204 based on this asynchronous callback. Exemplary embodiments thus enable a proactive scheme of notification/software updates using asynchronous callbacks.

FIG. 3 illustrates client updates. The client device 202 may also store and execute the update software application 216 that interfaces with the smart contract 212, perhaps using the APIs 214. The update software application 216 uses the APIs 214 to register the client device 202 with the smart contract 212 for software updates. So, when the software update 204 is written to the block 210 of data, the blockchain node 206 executes the smart contract 212 and retrieves the software update 204. The blockchain node 206 may then “push” or send the software update 204 via the blockchain network 200 and/or the communications network 220 to the network address (e.g., Internet Protocol address) associated with the client device 202. When the client device 202 receives the software update 204, the update software application 216 instructs the client device 202 to apply, download, and/or install the software update 204. The client device 202 is thus updated with the latest software version or configuration for best performance, user experience, security, operability, and any other factor.

The client device 202 may also “pull” the software update 204. When the blockchain node 206 obtains the software update 204, the blockchain node 206 may send a software update notification 218 to the network address (e.g., Internet Protocol address) associated with the client device 202. The software update notification 218 may be routed via the blockchain network 200 and/or a communications network 220 (such as Internet). When the client device 202 receives the software update notification 218, the update software application 216 instructs the client device 202 to retrieve the software update 204. The client device 202, for example, may send a software update request 222 via the blockchain network 200 and/or the communications network 220 to the network address (e.g., Internet Protocol address) associated with the blockchain node 206. The software update request 222 may specify the appropriate API 214 for requesting the software update 204 written to the block 210 of data. The blockchain node 206, in response to receiving the software update request 222, reads/retrieves the software update 204 and generates a software update response 224 including or specifying the software update 204. The blockchain node 206 sends the software update response 224 (via the blockchain network 200 and/or the communications network 220) to the network address associated with the client device 202. When the client device 202 receives the software update response 224, the update software application 216 instructs the client device 202 to apply, download, and/or install the software update 204. The client device 202 is thus updated with the latest software version or configuration for best performance, user experience, security, operability, and any other factor.

Conventional update schemes are ineffective, costly, and prone to failure. As the reader likely understands, the information handling system 100 (such as the client device 202 and/or the blockchain node 206) may require software updates. These software updates (e.g., drivers, BIOS, firmware, and software applications), however, are conventionally based on a centralized model. That is, software updates are stored by one (1), or perhaps a few, networked servers. The conventional, centralized, network server downloads the software update to all clients. That is, conventional schemes utilize a “pull” or “poll” operation in which the client device 202 requests the software updates. If a software update is available, the centralized network server delivers the software update from one (1), or perhaps a few, fixed network locations. However, as the reader may know, many users fail to select scheduled “auto-updates” for their devices. Indeed, it is estimated that over 75% of users fail to enable the “auto-update” feature for software. Simply put, the “auto-update” feature is ineffective. Moreover, because the conventional centralized update scheme may serve hundreds, thousands, or even millions of clients, the centralized network server may be quickly overwhelmed by repeated update requests. The centralized network server bogs down in performance and may even incur a hardware failure. The conventional centralized scheme is also exceptionally expensive, as the software updates must be routed via multiple different Content Delivery Networks (“CDNs”). Each CDN charges fees per download packet traffic, and urgent delivery of critical software updates incurs added network routing costs. The conventional update schemes are ineffective, costly, and prone to failure.

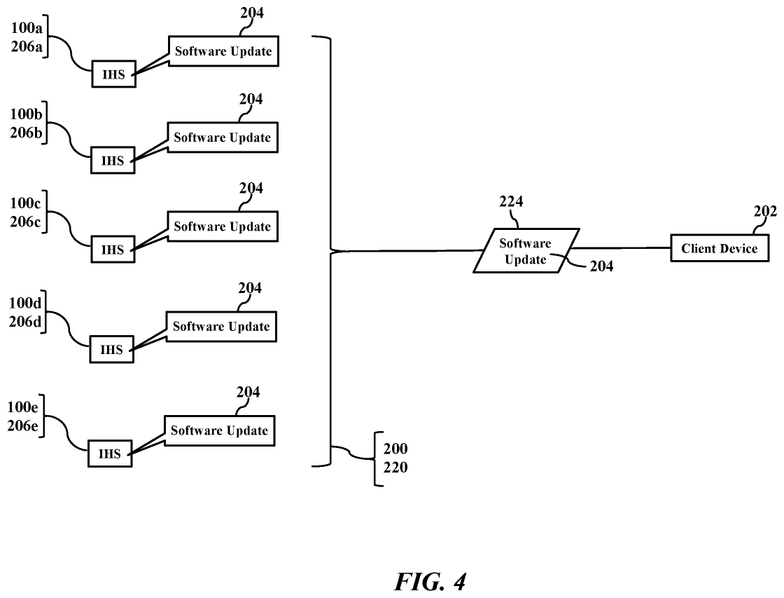

FIG. 4 illustrates improved computer functioning, according to exemplary embodiments. Because the software update 204 is distributed to each one of the blockchain nodes 206, there are many copies (perhaps hundreds or even thousands) of the software update 204. Again, such a large quantity of geographically-dispersed blockchain nodes 206 is too difficult to illustrate. FIG. 4 thus simply illustrates five (5) blockchain nodes 206a-e storing five (5) copies of the software update 204. The blockchain nodes 206a-e are likely physically-located in different cities, states, countries, and/or even continents. The software update 204 may represent a Best Known Configuration (or “BKC”), a Desired Secure State (or “DSS”), or any other configuration settings and software (e.g., drivers, BIOS, firmware, and software applications) that may be individually tailored or specified for optimum performance and usability of the client device 202. Because the blockchain nodes 206 are geographically dispersed as network end points, any of the blockchain nodes 206 may be selected or commanded to retrieve/send the software update 204. No one blockchain node 206, in other words, is responsible for delivering/downloading/specifying the software update 204. Single or a few points of failure are eliminated. The many blockchain nodes 206 thus share the burden of updating the client devices 202. The decentralized, peer-to-peer notification infrastructure thus greatly reduces individual requests per machine, which greatly increases hardware (processors 102/104 and memory 120) resources, performance, and uptime. Because the blockchain nodes 206 share the burden of storing and providing the software update 204, no single machine/computer carries the burden and hardware failures are greatly reduced. Computer hardware and software resources are reduced for allocation to other tasks (e.g., creating new blocks, consensus, proof of work, difficulty). The processors 102/104 are available to execute more instructions, and reduced bytes in the memory 120 are consumed. Hardware and software resources are conserved, and perform faster/better, with increased reliability.

Exemplary embodiments also greatly reduce costs. Because the blockchain nodes 206 are geographically dispersed as network end points, fewer Content Delivery Networks are required. That is, once approximate geographic and/or network locations associated with the client device 202 and the blockchain nodes 206 are known, exemplary embodiments may select the blockchain node 206 sharing the same Content Delivery Network and/or the same/similar geographic location. Should the client device 202 and the blockchain node 206 be accessible via a single, common communications network 220, for example, only a single network provider need be paid to route and deliver the software update 204. Multiple Content Delivery Networks may thus be avoided, especially when a single network provider and/or CDN can establish a communications routing path from a particular (closest) blockchain node 206 to the client device 202. Moreover, once approximate geographic and/or network locations associated with the client device 202 and the blockchain nodes 206 are known, exemplary embodiments may select which of the blockchain nodes 206 is best suited to provide the software update 204, in order to reduce the number of CDNs utilized, to utilize CDNs offering better/advantageous routing/delivery terms/costs, to reduce network packet traffic/delay/congestion in the blockchain network 200, or to achieve any other networking/performance goal.

Exemplary embodiments further improve computer functioning. The decentralized, peer-to-peer blockchain-based software update scheme (illustrated in FIGS. 2-4) provides a fully-scalable solution that monitors for software updates 204, that deploys the software updates 204, and that may even force or command clients to install the software update 204. The decentralized, peer-to-peer blockchain-based scheme remediates software and hardware discrepancies, repairs software and hardware errors, and recovers lost/changed/incorrect configuration settings and software. The decentralized, peer-to-peer blockchain-based scheme may also gather and/or utilize telemetry data to reduce network traffic and network costs. Exemplary embodiments also bring blockchain analytics to edge devices, thus providing a business case for Blockchain as a Service (BaaS) solutions in the client serviceability business. Exemplary embodiments provide full automation of data control processes, hence making it easier for customers to control their personal data. Exemplary embodiments may further reduce costs by adding the participation of new parties to the blockchain 208, such as remediation apps, service technicians, laptop resellers, parts/device recyclers, and other important service stakeholders. Exemplary embodiments allow enterprise customers to perform Edge Analytics leveraging the blockchain 208 infrastructure.

Exemplary embodiments further improve computer functioning. Many computer security vulnerabilities are exploited or attacked prior to an execution of an operating system (such as the well-known family of the MICROSOFT® WINDOWS® graphical operating systems). Conventional update schemes are thus conducted after the operating system boots/executes. Conventional update schemes may thus be too late to apply pre-OS fixes for security vulnerabilities from getting exploited. Exemplary embodiments, instead, may be implemented in an embedded, “light-weight” operating system installed by an OEM computer manufacturer. The embedded OS executes prior to a boot operation and may thus be updated prior to execution.

The smart contract 212 may be executable code that runs on the blockchain 208. The smart contract 212 has programming statements representing or specifying what, when, and how machines are notified of the software update 204. The smart contract 212 may also define the network location/resource from where the software update 204 is retrieved. Whatever the terms specified by the smart contract 212, the smart contract 212 may automatically execute once predetermined logical rules, conditions, or code is satisfied. The smart contract 212 may thus be expressed in a programming language. Smart contracts are generally known, so this disclosure will not dwell on the known aspects.

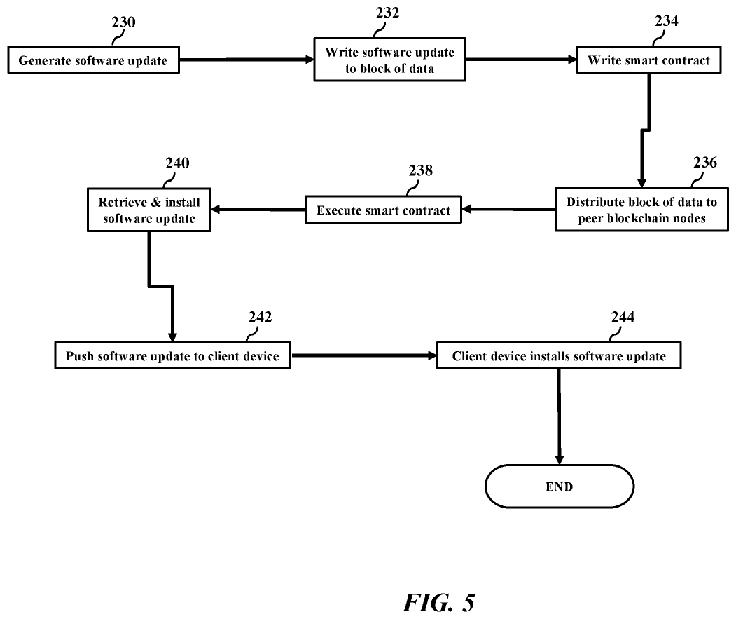

FIG. 5 is a flowchart or algorithm illustrating a decentralized, peer-to-peer blockchain-based software update scheme for consumer devices, according to exemplary embodiments. The software update 204 is generated (Block 230). Because there are millions of combinations of hardware components and software applications, there will likely be many different packages of the software update(s) 204, depending on the hardware and software resources installed on the client device 202. The software update 204 may thus be defined according to a registration process, perhaps based on a hardware and software inventory associated with the client device 202 (e.g., manufacturer, model number, serial number, processor 102/104, memory 120, etc.). The software update 204 may have any formatting or content, but a metadata description is perhaps easiest to understand and easiest to implement. However the software update 204 is created, the software update 204 is written, perhaps as a blockchain transaction, to the block 210 of data (Block 232). The smart contract 212 is written to the blockchain 208 (Block 234) (such as the block 210 of data). The smart contract 212 may define or specify which client devices are notified of the software update 204 (again, perhaps according to registration of the hardware and software inventory associated with the client device 202). The block 210 of data is copied and distributed to the blockchain nodes 206 (Block 236). When the consumer client device 202 is one of the blockchain nodes 206, the blockchain nodes 206 execute the smart contract 212 (Block 238). The blockchain nodes 206 (such as the consumer client device 202) retrieve and install the software update 204 (Block 240). A nodal-side Web3.0 application, stored and executed by the blockchain node 206, may instruct or cause the blockchain node 206 to write the software update 204 to the block 210 of data, append the smart contract 212, execute the smart contract 212, and/or publish/distribute the block 210 of data. Once the block 210 of data publishes within the blockchain network 200, the smart contract 212 alerts the blockchain network 200 to the software update 204.

FIG. 5 also illustrates client updates. The smart contract 212 may optionally instruct the blockchain node 206 to send or distribute the software update 204 to the consumer client device 202 (Block 242). The client device 202 may then apply or install the software update 204 (Block 244).

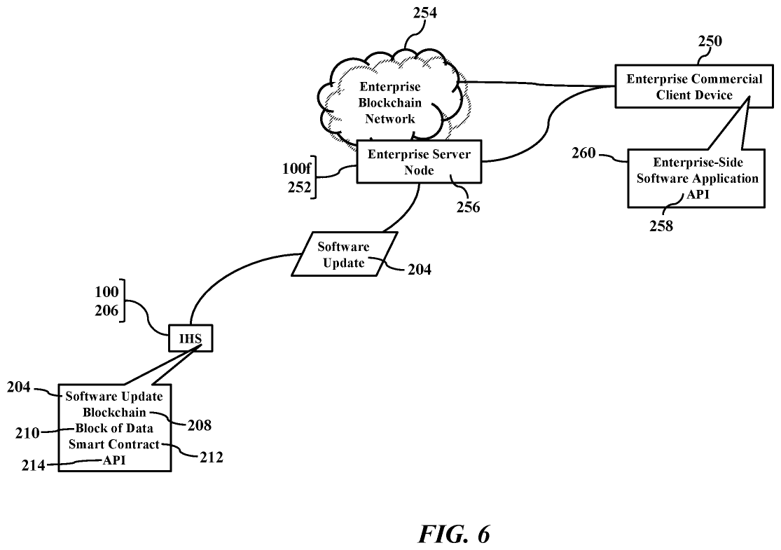

FIG. 6 is a block diagram illustrating a blockchain-based configuration scheme for commercial devices operating in an Enterprise network, according to exemplary embodiments. The software update 204 is written to the blockchain 208 and dispersed into the blockchain network 200 (as explained with reference to FIGS. 2-5). Here, though, the software update 204 may also be applied to Enterprise machines affiliated or associated with an Enterprise commercial customer (illustrated as an Enterprise commercial client device 250). The information handling system 100 (operating as the blockchain node 206) may thus interface with another information handling system 100f functioning as an Enterprise server node 252 accessible to a private Enterprise blockchain network 254 (perhaps using Enterprise-specific APIs). That is, an Enterprise commercial customer may utilize or operate its own private Enterprise blockchain network 254. The blockchain node 206 may send or push the software update to the IP address associated with the Enterprise server node 252. However, the Enterprise server node 252 may run a Web3 application which interfaces with the smart contract 212 deployed on the blockchain node 206. The Enterprise server node 252 may then invoke the API 214 to retrieve the software update 204. Regardless, the Enterprise commercial customer may further specify and deploy an Enterprise-specific smart contract 256 on each Enterprise server node 252 associated with the Enterprise blockchain network 254. When Enterprise server node 252 receives the software update 204, the Enterprise server node 252 adds or writes the software update 204 to the private Enterprise blockchain network 254. The Enterprise server node 252 executes the Enterprise-specific smart contract 256, which causes the Enterprise server node 252 to push/send/distribute the software update 204 the Enterprise commercial client device(s) 250. The Enterprise commercial client device 250 may then apply or install the software update 204.

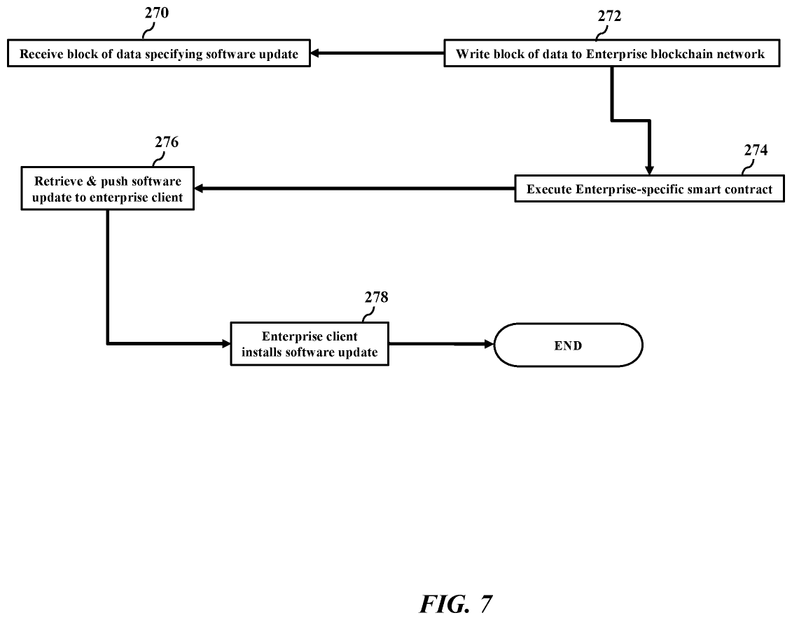

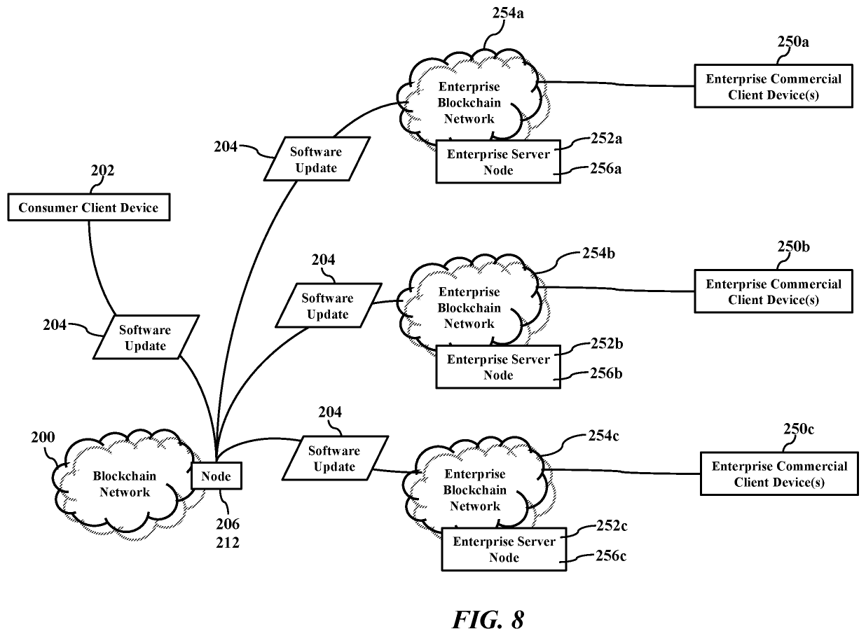

FIG. 7 is a flowchart or algorithm illustrating a decentralized, peer-to-peer blockchain-based configuration scheme for Enterprise commercial client machines, according to exemplary embodiments. The block 210 of data is received by the Enterprise server node 252 associated with the private Enterprise blockchain network 254 (Block 270). The Enterprise server node 252 writes the block 210 of data to the Enterprise blockchain network (Block 272). The Enterprise server node 252 executes the Enterprise-specific smart contract 256 (Block 274), which instructs the Enterprise server node 252 to download and to push the new software update 204 to the appropriate Enterprise commercial machines (such as the Enterprise commercial client device 250) (Block 276). Again, the Enterprise commercial machines may register for software updates, based on a hardware and software inventory (e.g., manufacturer, model number, serial number, processor 102/104, memory 120, etc.). The Enterprise commercial client device 250 may then apply or install the software update 204 (Block 278).

As FIGS. 2 and 4-7 illustrate, commercial and consumer machines may have slightly different update infrastructures. All the appropriate client nodes (whether the consumer client device 202 or the Enterprise commercial client device 250) are notified of the latest or updated software update 204. However, the update software application 216, stored and executed by the consumer client device 202, interacts with the smart contract 212 deployed on the blockchain network 200 (such as a public blockchain service or resource). Consumer machines may thus fetch the software update 204 directly from a publicly-accessible blockchain network. Commercial client machines (e.g., the Enterprise commercial client device 250), however, may interact with the Enterprise-specific smart contract 256 deployed on the Enterprise server node 252 and the Enterprise blockchain network 254. Commercial machines may thus fetch the software update 204 directly from a private blockchain network.

FIG. 8 illustrates general scalability of decentralized, peer-to-peer blockchain-based configurations, according to exemplary embodiments. As the reader may realize, there are many different blockchain networks. Some blockchain networks are publicly-accessible, whereas other blockchain networks are privately accessible. FIG. 8 thus illustrates a general, and scalable, blockchain-based architecture for notifying client machines of software updates. The software update 204 is written to a publicly-accessible blockchain network (such the blockchain network 200). The software update 204 is thus distributed among blockchain nodes in the blockchain network 200. The smart contract 212, deployed via the blockchain network 200, is executed and instructs the node 206 to push the software update 204 to consumer machines (such as the consumer client device 202). The consumer machines may then install the software update 204. The blockchain node 206, however, may also alert commercial machines operating in different enterprise network environments. That is, the blockchain node 206, operating in perhaps the publicly-accessible blockchain network 200, may also inform private blockchain networks of the software update 204. The blockchain node 206, for example, may push the software update 204 to blockchain nodes operating in, or affiliated with, the private blockchain networks. As this disclosure above explains, the software update 204 may be also sent to multiple and different Enterprise server nodes 252a-c operating in the Enterprise blockchain network 254a-c. The corresponding Enterprise-specific smart contract 256a-c is executed. Each Enterprise server node 252a-c may push the software update 204 to the corresponding Enterprise commercial client device 250a-c. Alternatively, each Enterprise server node 252a-c may notify or alert its corresponding Enterprise commercial client device 250a-c of the software update 204, and the Enterprise commercial client device 250a-c may request or pull the software update 204. The software update 204 may thus be dispersed, in many decentralized fashions, for peer-to-peer delivery via public and private blockchains.

Cryptographic proofs may be recorded. When the blockchain node 206 sends the software update 204 to any client machine (such as the consumer client device 202), the blockchain node 206 may generate a cryptographic proof. The cryptographic proof proves that the software update was sent to the client machine. As a simple example, the blockchain node 206 may generate the cryptographic proof by concatenating and hashing a binary combination of the software update 204 with a unique identifier associated with the client device 202. The blockchain node 206 may then write/record the cryptographic proof to the blockchain 208. Similarly, the blockchain node 206 may generate a cryptographic proof that the software update 204 was sent to the Enterprise server node 252 by concatenating and hashing a binary combination of the software update 204 with a unique identifier associated with the Enterprise server node 252. The blockchain node 206 may then write/record the cryptographic proof to the blockchain 208. The Enterprise server node 252 may generate a cryptographic proof that the software update 204 was sent to the Enterprise commercial client device 250 by concatenating and hashing a binary combination of the software update 204 with a unique identifier associated with the Enterprise commercial client device 250. The Enterprise server node 252 may then write/record the cryptographic proof to the Enterprise blockchain network 254.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method executed by an information handling system that installs a software update, the method comprising:
receiving, by the information handling system, a smart contract written to a blockchain;
fetching, by the information handling system, the software update by executing the smart contract written to the blockchain; and
installing, by the information handling system, the software update fetched by executing the smart contract written to the blockchain.

2. The method of claim 1, further comprising generating the smart contract.

3. The method of claim 1, further comprising writing the smart contract to the blockchain.

4. The method of claim 1, further comprising writing the software update to the blockchain.

5. The method of claim 1, further comprising sending the software update to an Enterprise server node associated with an Enterprise blockchain network.

6. A system that notifies a client device of a software update, the system comprising:
a hardware processor; and
a memory device accessible to the hardware processor, the memory device storing instructions that when executed by the hardware processor perform operations, the operations including:
receiving a smart contract written to a blockchain;
fetching the software update by executing the smart contract written to the blockchain;
identifying the client device associated with the software update by executing the smart contract written to the blockchain; and
sending the software update to the client device identified by the executing of the smart contract.

7. The system of claim 6, wherein the operations further include receiving a software update request from the client device identified by the executing of the smart contract.

8. The system of claim 7, wherein in response to the receiving of the software update request, the operations further include retrieving the software update.

9. The system of claim 8, wherein the operations further include sending a software update notification to the client device.

10. The system of claim 8, wherein the operations further include sending the software update to an Enterprise server node associated with an Enterprise blockchain network.

11. A memory device storing instructions that when executed by a hardware processor perform operations that cryptographically prove a client device was notified of a software update, the operations including:
generating the software update;
writing the software update as a blockchain transaction to a block of data associated with a blockchain;
publishing the software update written to the block of data via a blockchain network associated with the blockchain;
identifying the client device associated with the software update by executing a smart contract deployed via the blockchain network;
sending a software update notification to the client device identified by the executing of the smart contract, wherein the software update notification alerts the client computer of the software update written to the block of data associated with the blockchain; and
generating a cryptographic proof of the sending of the software update notification to the client device by hashing the software update with a unique identifier associated with the client device.

12. The memory device of claim 11, wherein the operations further include receiving a software update request from the client device identified by executing the smart contract.

13. The memory device of claim 12, wherein in response to the receiving of the software update request, the operations further include retrieving the software update written to the block of data associated with the blockchain.

14. The memory device of claim 13, wherein the operations further include sending the software update to the client device.

15. The memory device of claim 11, wherein the operations further include sending the software update written to the block of data to an Enterprise server node associated with an Enterprise blockchain network.
